(19) United States
(12) Patent Application Publication
(10) Pub. No.: US 2026/0305529 A1
(43) Pub. Date: Oct. 8, 2026

(54) WINDROW SENSING ATTACHMENT FOR A MOWER IMPLEMENT

(71) Applicant: Deere & Company, Moline, IL (US)

(72) Inventor: Darin L. Roth, Mount Pleasant, IA (US)

(21) Appl. No.: 19/098,030

(22) Filed: Apr. 2, 2025

(51) Int. Cl. A01D 34/66; A01D 34/00; A01D 43/00

(52) U.S. Cl. CPC A01D 34/667; A01D 34/006; A01D 43/006

(57) ABSTRACT

A windrow sensing attachment includes a frame assembly having an arm attachment bar extend along a longitudinal bar axis. Each respective one of a plurality of arms includes an attachment end that is pivotably coupled to the arm attachment bar for rotational movement about the longitudinal bar axis and extends to a distal contact end for following a contour of a windrow. An arm position sensor is operable to detect data related to a rotational position of each arm relative to the longitudinal bar axis. An attachment controller determines a respective position of each of the arms relative to a ground surface and generates a cross-sectional profile of the windrow based on the respective position of each one of the arms.

### TECHNICAL FIELD

The disclosure generally relates to a windrow sensing attachment, and a mower implement including the windrow sensing attachment.

### BACKGROUND

A mower implement may be used to cut standing crop material, such as but not limited to, hay and forage crops. The mower implement includes a cutter system which cuts the standing crop material, and may include forming elements, such as but not limited to, a left and/or right side forming shield, a swath board, etc., that form the crop material into a windrow on a ground surface.

Windrow formation has an immense impact on crop drying and the timeliness of follow-up operations after mowing. Density changes along the length of the windrow and across a width of the windrow are often not reflected in their surface geometry, i.e., the cross-sectional shape of the windrow. In other words, a perfectly formed windrow cross-section may not exhibit a consistent density. During a dry down period, regions of higher density do not “deflate” in height as much as other, more aerated regions. This leaves a very non-uniform crop in terms of moisture content for the next harvest operation.

In order to better control the mower implement, particularly, the forming elements thereof, and in order to better plan the future harvest operations, e.g., raking, tedding, baling, etc., it is important to understand the characteristics of the windrow, including the cross-sectional shape of the windrow, the density of the crop material within the windrow, and the mass of the crop material included in the windrow.

### SUMMARY

A windrow sensing attachment is provided. The windrow sensing attachment includes a frame assembly configured for attachment to a tow vehicle. The frame assembly includes an arm attachment bar that extends along a longitudinal bar axis in a direction transverse to a direction of travel during operation. The windrow sensing attachment further includes a plurality of arms. Each respective one of the plurality of arms includes an attachment end that is pivotably coupled to the arm attachment bar for rotational movement about the longitudinal bar axis. Each respective one of the plurality of arms extends along a respective longitudinal arm axis, substantially parallel to the direction of travel, to a distal contact end. The distal contact end of each respective one of the plurality of arms is configured to contact and follow a contour of an upper surface of a windrow. An arm position sensor is operable to detect data related to a rotational position of each respective one of the plurality of arms relative to and about the longitudinal bar axis. The arm position sensor may further generate an arm position signal indicative of the sensed data. The windrow sensing attachment may further include an attachment controller having a processor and a memory having a windrow mapping algorithm stored thereon. The processor is operable to execute the windrow mapping algorithm to determine a respective position of each one of the plurality of arms relative to a ground surface from the arm position signal of the arm position sensor. The attachment controller may generate a cross-sectional profile of the windrow, extending perpendicular to the direction of travel, based on the respective position of each one of the plurality of arms. The cross-sectional profile of the windrow may be stored in a data file on the memory of the attachment controller, and/or displayed on a visual display screen of an associated work station.

In one implementation of the disclosure, the arm position sensor may include a plurality of rotational position sensors. Each respective one of the plurality of arms may be associated with and include a respective one of the plurality of rotational position sensors attached thereto. As such, each individual rotational position sensor may detect data related to a position of the respective arm to which it is associated with.

In one implementation of the disclosure, the arm position sensor may include a plurality of markers. Each respective one of the plurality of arms may include a respective one of the plurality of markers attached thereto. The arm position sensor may further include an image sensor positioned to capture an image of the plurality of markers throughout a range of motion of the plurality of arms. The processor may be operable to execute the windrow mapping algorithm to determine the respective position of each respective arm from the image captured by the image sensor by identifying a location of the marker on each respective arm using an image analysis algorithm.

In one aspect of the disclosure, the windrow sensing attachment may include a plurality of force generators. Each respective one of the plurality of arms may include a respective force generator coupled thereto for generating a downward force at the distal contact end thereof for pressing downward against the windrow with a defined constant force.

In one implementation of the disclosure, each respective one of the plurality of force generators includes a biasing element, e.g., a spring, interconnecting the frame assembly and the respective arm coupled to that respective force generator. The biasing element may generate the defined constant force via an inherent spring force biasing the arm against the arm attachment bar. In another implementation of the disclosure, each respective one of the plurality of force generators may include a weight attached to the distal contact end of the respective arm coupled to that respective force generator. The weight may generate the defined constant force via gravitational forces acting on the weight.

In one aspect of the disclosure, the processor may be operable to execute the windrow mapping algorithm to estimate a pressure applied onto the windrow along the cross-sectional profile based the downward force generated at the distal contact end of each one of the plurality of arms, and the area on which the downward force is applied. The constant downward force generated by each of the respective force generators functions to compress the crop material under the distal contact end to a generally constant pressure. Accordingly, the density of the crop material in the windrow under the distal contact end of each of the arms may be determined, calculated, or estimated based on the value of the constant downward force, the area of the distal contact end in contact with and engaging the crop material of the windrow, and the height of the windrow under the distal contact end of the arm.

In one aspect of the disclosure, the processor may be operable to execute the windrow mapping algorithm to estimate a crop mass of the windrow based on the cross-sectional profile of the windrow under the applied constant pressure of the distal contact ends of the arms, and a distance traveled along the windrow in the direction of travel. The density of the crop material in the window may be determined as described above. The distance traveled along the windrow may enable the attachment controller to integrate the cross-sectional profile over a distance, thereby providing a mass of the windrow.

In one aspect of the disclosure, each respective one of the plurality of arms may include a respective crop contacting element attached to the distal contact end thereof. The crop contacting element may include one of, but is not limited to, a roller or a skid plate.

In one aspect of the disclosure, the windrow sensing attachment may include an attachment actuator that is coupled to the frame assembly. In one implementation, the attachment actuator interconnects the frame assembly with a support structure of a mower implement. The attachment actuator may be configured for positioning the frame assembly relative to the ground surface.

In one implementation of the disclosure, the windrow sensing attachment may include a frame position sensor operable to detect data related to the position of the arm attachment bar relative to the ground surface, and generate a bar position signal indicative thereof. The processor may be operable to execute the windrow mapping algorithm to determine an elevation of the arm attachment bar relative to the ground surface from the bar position signal from the frame position sensor. The elevation of the arm attachment bar may be used to determine the elevation and/or position of each respective arm relative to the ground surface.

In one aspect of the disclosure, each respective one of the plurality of arms is independently moveable relative to the others of the plurality of arms. The distal contact ends of the plurality of arms are aligned in a row extending across the windrow, immediately adjacent each other, such that each respective distal contact end follows a discrete region of the windrow, thereby providing positional height data regarding that particular discrete region for generating the cross-sectional profile of the windrow.

In one aspect of the disclosure, the windrow sensing attachment is combined with the mower implement. The mower implement may include, for example, a support structure rotatably supporting at least one ground engaging element, and a crop cutter system coupled to the support structure. The crop cutter system is configured for cutting standing crop and positioning the cut crop material in the windrow on the ground surface. The windrow sensing attachment is attached to the mower implement rearward of the crop cutter system relative to the direction of travel of the mower implement during operation.

Accordingly, the windrow sensing attachment described herein is operable to collect accurate data related to the shape of the windrow, the volume of the windrow, and the mass of the crop material within the windrow. This data may be used to control various operating parameters of the mower implement, e.g., the forming elements, the crop cutting system. Additionally, this data may be used to plan and schedule future harvest operations, such as but not limited to, raking, tedding, baling, etc.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic side view of an example implementation of a mower implement including a windrow sensing attachment coupled to a rearward end thereof.

FIG. 2 is a schematic exploded view of crop cutter system of the mower implement.

FIG. 3 is a schematic perspective view of the windrow sensing attachment showing a first implementation of an arm position sensor system.

FIG. 4 is a schematic perspective view of the windrow sensing attachment showing a second implementation of the arm position sensor system.

FIG. 5 is a schematic side view of the windrow sensing attachment moving over a windrow.

FIG. 6 is a schematic end view of the windrow sensing attachment moving over the windrow.

FIG. 7 is a schematic representation of a cross-sectional profile of the windrow generated by the windrow sensing attachment.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

The terms “forward”, “rearward”, “left”, and “right”, when used in connection with a moveable implement and/or components thereof are usually determined with reference to the direction of travel during operation, but should not be construed as limiting. The terms “longitudinal” and “transverse” are usually determined with reference to the fore-and-aft direction of the implement relative to the direction of travel during operation, and should also not be construed as limiting.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

As used herein, “e.g.” is utilized to non-exhaustively list examples, and carries the same meaning as alternative illustrative phrases such as “including,” “including, but not limited to,” and “including without limitation.” As used herein, unless otherwise limited or modified, lists with elements that are separated by conjunctive terms (e.g., “and”) and that are also preceded by the phrase “one or more of,” “at least one of,” “at least,” or a like phrase, indicate configurations or arrangements that potentially include individual elements of the list, or any combination thereof. For example, “at least one of A, B, and C” and “one or more of A, B, and C” each indicate the possibility of only A, only B, only C, or any combination of two or more of A, B, and C (A and B; A and C; B and C; or A, B, and C). As used herein, the singular forms “a”, “an” and “the” are intended to include the plural forms as well, unless the context clearly indicates otherwise. Further, “comprises,” “includes,” and like phrases are intended to specify the presence of stated features, steps, operations, elements, and/or components, but do not preclude the presence or addition of one or more other features, steps, operations, elements, components, and/or groups thereof.

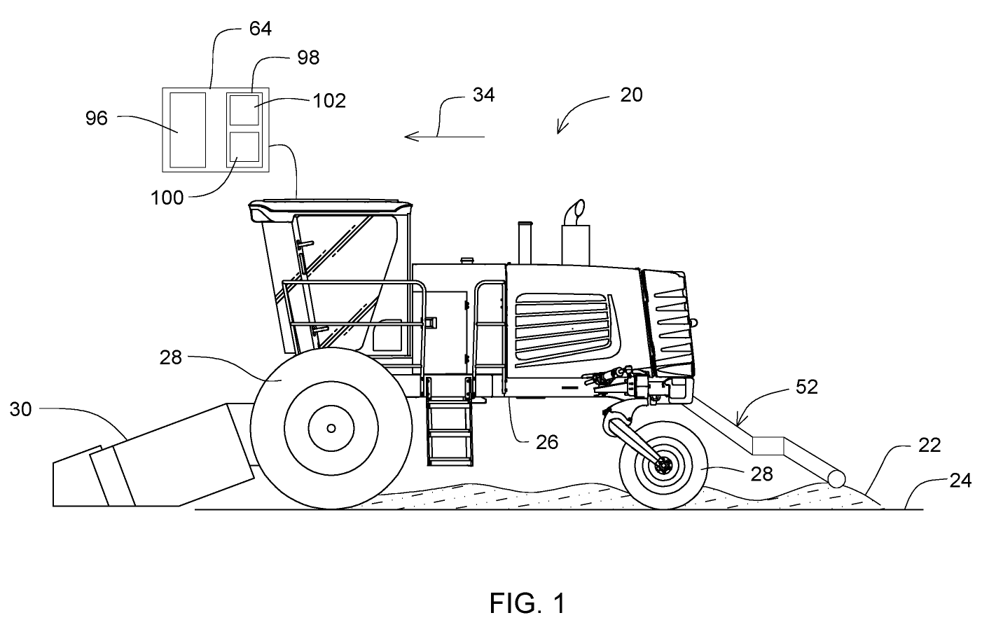

Referring to the Figures, wherein like numerals indicate corresponding parts throughout the several views, a mower implement is generally shown at 20. Referring to FIG. 1, the exemplary embodiment of the mower implement 20 shown in the Figures is configured for mounting to a forward end of an agricultural machine, such as a self-propelled windrower. However, it should be appreciated that the teachings of this disclosure may be applied to other platforms, such as but not limited to, the mower implement 20 being configured for connection to a conventional tractor, i.e., the mower implement 20 being a mower-conditioner drawn behind the tractor.

Referring to FIG. 1, the mower implement 20 is operable to mow and collect standing crop material in a field, and form the cut crop material into a windrow 22 on a ground surface 24 of a field. Optionally, the mower implement 20 may further condition the cut crop material as the crop material moves through the mower implement 20 to improve is drying characteristics.

Referring to FIG. 1, the mower implement 20 includes a support structure 26. The support structure 26 may include, but is not limited to, the various members, panels, supports, braces, beams, etc., necessary to support the various components and systems of the mower implement 20 as described below. The mower implement 20 may include at least one ground engaging element 28 rotatably coupled to the support structure 26. For example, and as shown in the Figures, the mower implement 20 is configured as a self-propelled windrower having a pair of front wheels and a pair of rear wheels rotatably coupled to the support structure 26 of the self-propelled windrower. In other implementations, (not shown) the mower implement 20 may be configured as a drawn mower/conditioner, having a pair of wheels attached to the support structure 26 of the mower/conditioner.

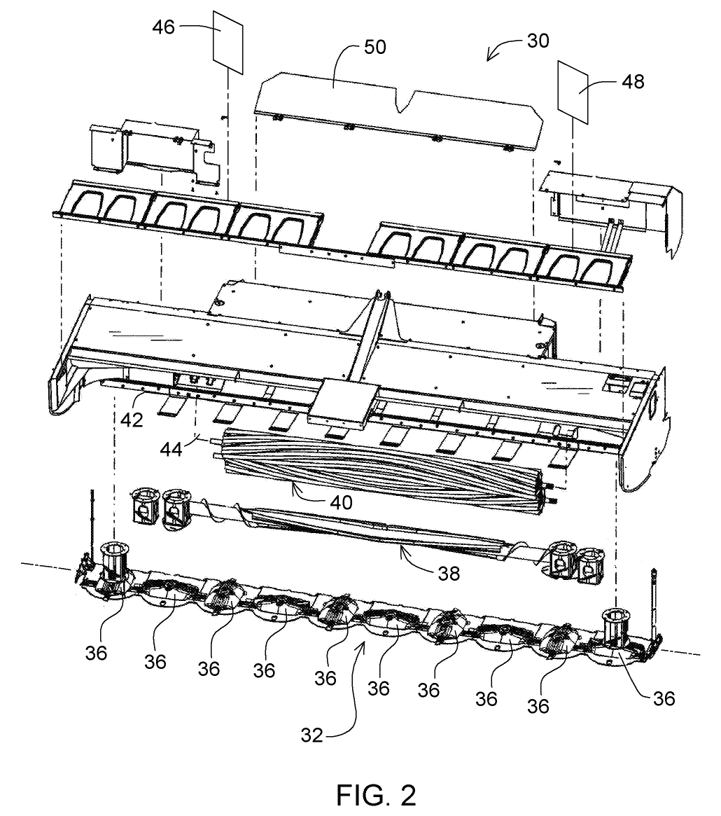

The mower implement 20 further includes a crop cutter system 30. The crop cutter system 30 is coupled to the support structure 26 of the mower implement 20, and is operable to cut standing crop material in the field. The crop cutter system 30 may include any mechanism that is capable of cutting the crop material, and positioning the cut crop material in the windrow 22 on the ground surface 24. Referring to FIG. 2, as shown in the Figures, the crop cutter system 30 is implemented as a rotary disc cutter bar 32. However, the crop cutter system 30 is not limited to the exemplary embodiment of the rotary disc cutter bar 32. As such, it should be appreciated that the crop cutter system 30 may vary from the exemplary embodiment shown in the Figures and described herein.

The exemplary embodiment of the crop cutter system 30 includes the cutter bar 32 supported by the support structure 26. The cutter bar 32 extends along an axis that is disposed generally transverse to a direction of travel 34 of the mower implement 20 during operation. The cutter bar 32 includes a plurality of cutting discs 36 spaced along the cutter bar 32 for rotation about respective vertical axes. Each of the cutting discs 36 is coupled to an upright drive shaft to which power is coupled for causing them to rotate in appropriate directions, for delivering cut crop material to an auger 38 disposed rearward of the crop cutter system 30.

Referring to FIG. 2 the auger 38 is rotatably mounted to the support structure 26, and passes in front of a crop conditioning system 40. In particular, the auger 38 is positioned in front of and lower than the crop conditioning system 40. The auger 38 includes a central cylindrical drum with a central portion and outer ends. The outer ends of the auger 38 include flighting, and a plurality of fins is attached to the central portion. In operation, the design of the auger 38 enables the delivery of cut crop material into the crop conditioning system 40.

The crop cutter system 30 delivers cut crop material to the auger 38, which in turn delivers the cut crop material rearward for further processing by the crop conditioning system 40. The example implementation of the crop conditioning system 40 includes an upper conditioner roll 42 and a lower condition roll 44. The crop conditioning system 40 is positioned to receive crop material between the upper conditioner roll 42 and the lower condition roll from the crop cutter system 30, whereby the crop material is scraped, bent, abraded, and otherwise conditioned to improve dry down characteristics. It should be appreciated that various other types of crop conditioning systems may be used instead of or in addition to the crop conditioning system 40 shown in the Figures and described herein. Such other crop conditioning systems may include, but are not limited to, flail/impeller conditioners, and the like.

The conditioned crop material is expelled rearward by the crop conditioning system 40, and is formed into the windrow 22 or swath by a right vertical forming shield 46, a left vertical forming shield 48, and a generally horizontal swath board 50. As is understood by those skilled in the art, relative positions of each of the left vertical forming shield 48, the right vertical forming shield 46, and the swath board 50 may be adjusted to control the cross-sectional profile of the windrow 22, i.e., the profile of the windrow 22 cut across a width of the windrow 22, perpendicular to the direction of travel 34 of the mower implement 20 during operation. While the cross-sectional profile of the windrow 22 may be generally shaped by the left vertical forming shield 48, the right vertical forming shield 46, and the swath board 50, the density of the crop material across the width of the windrow 22 may vary, i.e., the density of the windrow 22 across the width of the windrow 22 is inconsistent and variable. Variations in the density of the crop material within the windrow 22 greatly affect dry down times of the crop material. Additionally, variations in the density of the crop material within the windrow 22 make it difficult to estimate the mass and/or volume of the crop material within the windrow 22.

As shown in FIG. 1, in order to determine and/or identify characteristics of the windrow 22 and/or the crop material in the windrow 22, the mower implement 20 may include a windrow sensing attachment 52 attached to a rearward end of the mower implement 20, i.e., rearward of the right vertical forming shield 46, the left vertical forming shield 48, and the swath board 50. The windrow sensing attachment 52 is configured to compress the crop material across the windrow 22 under a generally consistent pressure, and then measure the height 104 of the windrow 22 at discrete regions 74 and/or locations across the width of the windrow 22 to develop a cross-sectional profile of the windrow 22 under the consistent downward pressure. The height 104 of the windrow 22 at the different discrete regions 74 or locations across the windrow 22 may be combined with the pressure applied above each location to determine a density of the crop material in the windrow 22 at that location. This information may be used to control various aspects of the crop cutter system 30, including but not limited to, a cutter speed, a conditioning roll speed, a forming shield and swath board 50 position, etc., as well as for planning/scheduling future harvest operations, including but not limited to, raking, tedding, baling, etc.

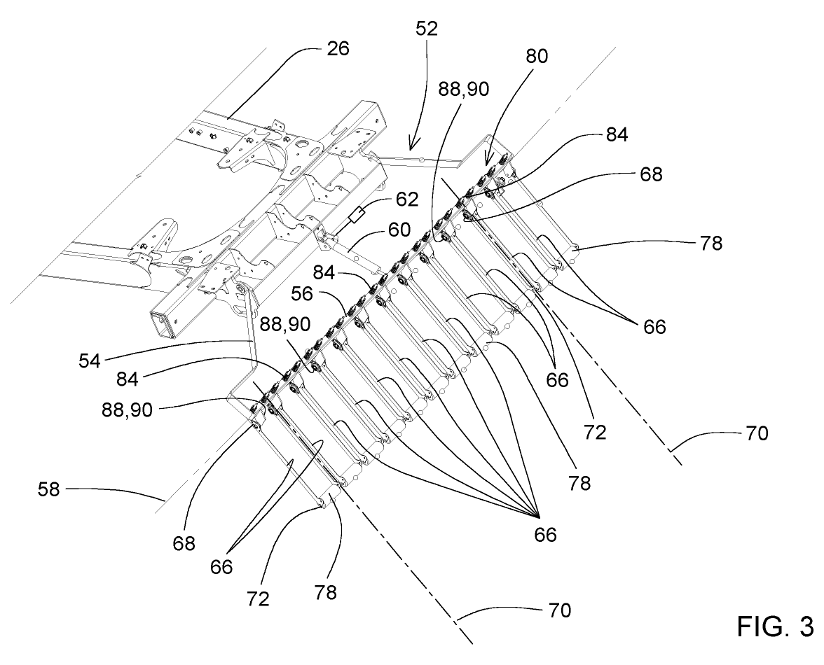

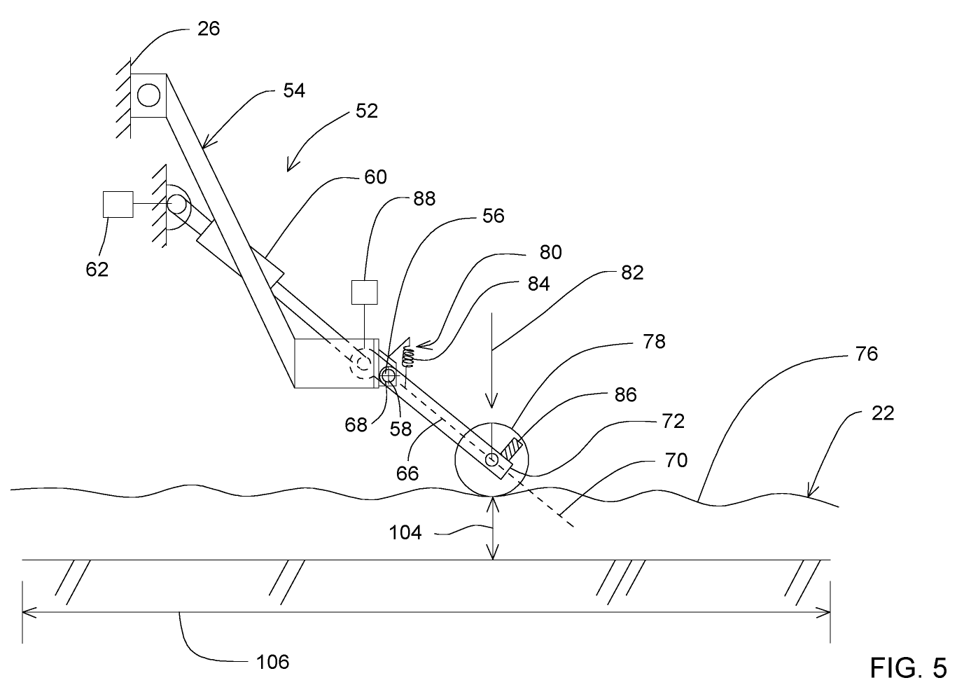

Referring to FIGS. 3-6, the windrow sensing attachment 52 includes a frame assembly 54 that is configured for attachment to a tow vehicle. The tow vehicle may include, for example, the mower implement 20. However, in other implementations, the tow vehicle may include some other movable platform that does not include the features and functions of the mower implement 20, such as, but not limited to, an agricultural tractor, a truck, an autonomous vehicle, etc. For example, and as shown in the Figures, the frame assembly 54 of the windrow sensing attachment 52 is configured for attachment to the rearward end of the support structure 26 of the self-propelled windrower. In other implementations, not shown herein, the frame assembly 54 of the windrow sensing attachment 52 may be configured for attachment to a support structure 26 of a mower/conditioner pulled by an agricultural tractor.

The frame assembly 54 may include all brackets, bars, connections, braces, etc. necessary to connect the windrow sensing attachment 52 to the support structure 26 of the tow vehicle. Particularly, the frame assembly 54 further includes an arm attachment bar 56. The arm attachment bar 56 extends along a longitudinal bar axis 58 in a direction that is transverse to the direction of travel 34 of the mower implement 20 during operation. In other words, the arm attachment bar 56 extends generally transverse across a width of the windrow sensing attachment 52, and across a width of the windrow 22.

The frame assembly 54 may further include an attachment actuator 60 configured for positioning the frame assembly 54 relative to the ground surface 24. In one example implementation, the attachment actuator 60 interconnects the frame assembly 54 and the support structure 26 of the mower implement 20. The attachment actuator 60 may include any device capable of raising and/or lowering the arm attachment bar 56 relative to the ground surface 24. In one example implementation the attachment actuator 60 may include, but is not limited to, a linear hydraulic cylinder operable to extend and retract to lower and raise the arm attachment bar 56. However, it should be appreciated that the attachment actuator 60 may be configured differently than the example implementation shown in the Figures and described herein.

The windrow sensing attachment 52 may further include a frame position sensor 62 that is operable to detect data related to the position of the arm attachment bar 56 relative to the ground surface 24. The frame position sensor 62 may further generate a bar position signal indicative of the detected or sensed data, and communicate the bar position signal to an attachment controller 64. In one example implementation, the frame position sensor 62 may include a rotational position sensor 90 configured to detect a rotational position of the arm attachment bar 56 relative to the support structure 26 of the mower implement 20. With a known position of the support structure 26 relative to the ground surface 24, the attachment controller 64 may use the detected data related to the rotational position of the arm attachment bar 56, in combination with the known position of the support structure 26 relative to the ground surface 24, to determine the position of the arm attachment bar 56 relative to the ground surface 24.

The windrow sensing attachment 52 further includes a plurality of arms 66. Each respective one of the arms 66 includes an attachment end 68 that is pivotably coupled to the arm attachment bar 56 for rotational movement about the longitudinal bar axis 58 of the arm attachment bar 56. Each respective one of the arms 66 extends along a respective longitudinal arm axis 70 to a distal contact end 72.

The longitudinal arm axis 70 of each respective one of the arms 66 is arranged to be generally parallel to the direction of travel 34 of the mower implement 20. As such, the arms 66 extend rearward of the arm attachment bar 56. The arms 66 are rotatable about the longitudinal bar axis 58, such that each respective arm 66 may angle downward toward the ground surface 24, be positioned generally horizontal and parallel with the direction of travel 34, or be angled upward away from the ground surface 24, or be positioned to any position therebetween.

The plurality of arms 66 are arranged in a side-by-side orientation, immediately adjacent one another. Each respective one of the arms 66 is independently moveable relative to all of the other arms 66. Each respective one of the arms 66 may be associated with a discrete region 74 of the windrow 22 disposed immediately under the distal contact end 72. The distal contact end 72 of each respective one of the arms 66 is configured to contact and follow a contour of an upper surface 76 of the windrow 22 as the windrow sensing attachment 52 moves along a length of the windrow 22. As such, the distal contact end 72 of each respective one of the arms 66 follows the upper surface 76 of the windrow 22 in the discrete region 74 of the windrow 22 associated with that respective one of the arms 66. It should be appreciated that as the height 104 of the discrete region 74 of the windrow 22 increases relative to the ground surface 24, the distal contact end 72 of the arm 66 of that discrete region 74 will raise to follow the upper surface 76 of the windrow 22. Similarly, it should be appreciated that as the height 104 of the discrete region 74 of the windrow 22 decreases relative to the ground surface 24, the distal contact end 72 of the arm 66 of that discrete region 74 will fall to follow the upper surface 76 of the windrow 22.

Each respective one of the plurality of arms 66 may include a respective crop contacting element 78 attached to the distal contact end 72 thereof. The crop contacting element 78 may be configured to guide the distal contact end 72 over the upper surface 76 of the windrow 22 and prevent the distal contact end 72 from cutting into or gouging the crop out of the windrow 22. For example, the crop contacting element 78 may include, but is not limited to, one of a roller, a slide, or a skid plate.

The windrow sensing attachment 52 may further include a plurality of force generators 80. Each respective one of the plurality of arms 66 includes a respective one of the plurality of force generators 80 coupled thereto. Each respective one of the plurality of force generators 80 is configured for generating a downward force at the distal contact end 72 of the respective one of the arms 66 associated with that force generator 80 for pressing downward against an area of the upper surface 76 of the windrow 22 with a defined constant force 82. The defined constant force 82 over the area on which the distal contact end 72 acts provides a generally consistent pressure applied onto the upper surface 76 of the windrow 22. With the distal contact end 72 of each respective arm 66 pressing downward against the upper surface 76 of the windrow 22 at the same defined constant force 82, the crop material underneath each respective distal contact end 72 is subjected to generally the same compressive force. Additionally, as described above, each respective distal contact end 72 is associated with a respective discrete region 74 of the cross section of the windrow 22. As such, with the distal contact end 72 of each respective arm 66 pressing downward against the upper surface 76 of the windrow 22 at the same defined constant force 82, the entire cross section of the windrow 22 is subjected to the generally same compressive pressure. It should be appreciated that upon the distal contact end 72 of each of the arms 66 moving past a specific longitudinal location of the windrow 22, the crop material rebounds to a degree, and returns to a non-uniform density.

In one implementation of the disclosure, each respective one of the plurality of force generators 80 may include a biasing element 84 interconnecting the frame assembly 54 and the respective arm 66 coupled to that respective force generator 80. The biasing element 84 may include, but is not limited to, a coil spring, a leaf spring, a compressible block, a pneumatic damper, a hydraulic damper, or some other device capable of exerting a consistent spring force against the respective arm 66 to bias the distal contact end 72 of the arm 66 downward. It should be appreciated that the biasing element 84 may be configured to work in tension or compression, and that each respective biasing device may include a respective bracket, mount, lever arm 66, etc., necessary to mount and attach the biasing element 84 to the respective arm 66 and the frame assembly 54.

In another implementation of the disclosure, each respective one of the plurality of force generators 80 may include a weight 86 attached to the distal contact end 72 of the respective arm 66 coupled to that respective force generator 80. The weights 86 may be used independently of or in combination with the biasing elements 84. The weight 86 may be incorporated into and part of the crop contacting element 78, or may be separate from the crop contacting element 78. With gravity acting on the respective weight 86 at the distal contact end 72 of each respective arm 66, the weight 86 provides a constant downward force biasing the arm 66 downward onto and against the windrow 22.

In one aspect of the disclosure, the force generator 80 may be adjustable to provide a different defined constant force 82 for different crop materials. For example, a windrow 22 formed from corn stalks may require a higher defined constant force 82 to compress the windrow 22 to a constant pressure than a windrow 22 formed from alfalfa. In one example implementation, the defined constant force 82 may be adjusted by adding or removing additional weight 86 from the distal contact end 72 of each respective arm 66. In another implementation, the defined contact force may be adjusted by lengthening or shortening each respective one of the arms 66 to increase and decrease a lever arm 66 affecting the predefined contact force respectively.

The windrow sensing attachment 52 further includes an arm position sensor 88 that is operable to detect data related to a rotational position of each respective one of the plurality of arms 66 relative to and about the longitudinal bar axis 58. Additionally, the arm position sensor 88 may generate and communicate an arm 66 position signal indicative of the data sensed or detected by the arm position sensor 88 to the attachment controller 64.

In one implementation of the disclosure, shown in FIG. 3, the arm position sensor 88 may include a plurality of rotational position sensors 90, with each respective one of the plurality of arms 66 having a respective one of the plurality of rotational position sensors 90 attached thereto. Each of the respective rotational position sensors 90 may detect data related to the rotational position of the arm 66 attached thereto relative to the arm attachment bar 56. For example, each of the respective rotational position sensors 90 may detect a rotational position about the longitudinal bar axis 58. Additionally, each of the respective rotational position sensors 90 may generate and communicate an arm 66 position signal to the attachment controller 64. Each of the rotational position sensors 90 may include, but are not limited to, a rotary potentiometer, a rotary encoder, a hall effect sensor, etc. In other implementations, each of the rotational position sensors 90 may include a linear sensor coupled to the respective arm 66 and configured to detect a range of motion or travel of the arm 66, which the attachment controller 64 may then convert into a rotational position of the arm 66 relative to the arm attachment bar 56.

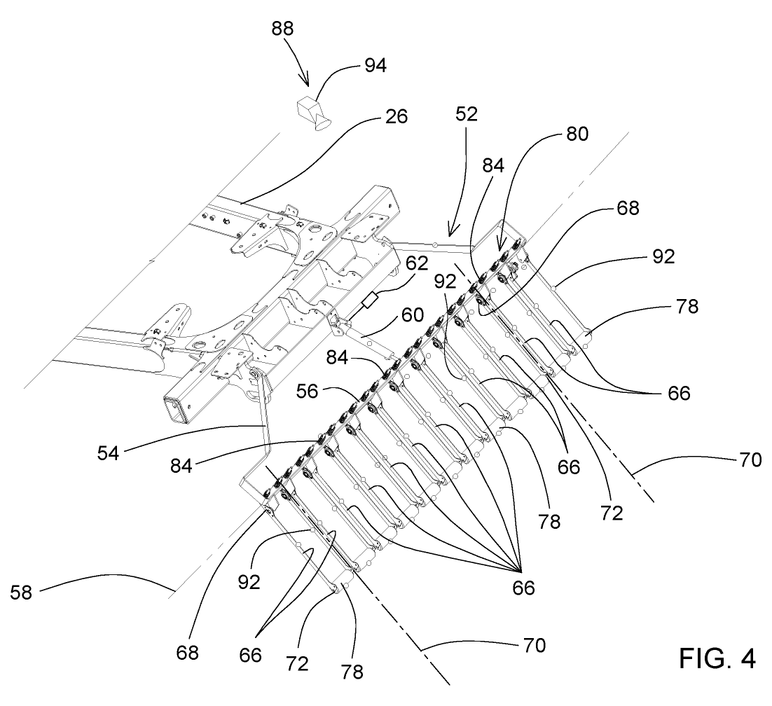

In another implementation, shown in FIG. 4, the arm position sensor 88 may include a plurality of markers 92, for example, reflective markers 92, with each respective one of the plurality of arms 66 having a respective one of the plurality of markers 92 attached thereto. The arm position sensor 88 may further include one or more image sensors 94 positioned to capture an image of the plurality of markers 92 throughout a range of motion of each of the plurality of arms 66. The attachment controller 64 may use image analysis software 100 and/or algorithms to identify the position of the respective markers 92 in images captured by the image sensor 94, and determine the location of the marker 92 and thereby the location of the arm 66 attached to each respective marker 92, relative to the arm attachment bar 56.

The attachment controller 64 may be disposed in communication with the bar position sensor and the arm position sensor 88. The attachment controller 64 is operable to receive data signals from the bar position sensor and/or the arm position sensor 88. While the attachment controller 64 is generally described herein as a singular device, it should be appreciated that the attachment controller 64 may include multiple devices linked together to share and/or communicate information therebetween. Furthermore, it should be appreciated that the attachment controller 64 may be located on the windrow sensing attachment 52, or may be located remotely from the windrow sensing attachment 52, such as on the mower implement 20, the tow vehicle, etc.

The attachment controller 64 may alternatively be referred to as a computing device, a computer, a controller, a control unit, a control module, a module, etc. The attachment controller 64 includes a processor 96, a memory 98, and all software, hardware, algorithms, connections, sensors, etc., necessary to manage and control the operation of the windrow sensing attachment 52. As such, a method may be embodied as a program or algorithm operable on the attachment controller 64. It should be appreciated that the attachment controller 64 may include any device capable of analyzing data from various sensors, comparing data, making decisions, and executing the required tasks.

As used herein, “controller” is intended to be used consistent with how the term is used by a person of skill in the art, and refers to a computing component with processing, memory, and communication capabilities, which is utilized to execute instructions (i.e., stored on the memory 98 or received via the communication capabilities) to control or communicate with one or more other components. In certain embodiments, the attachment controller 64 may be configured to receive input signals in various formats (e.g., hydraulic signals, voltage signals, current signals, CAN messages, optical signals, radio signals), and to output command or communication signals in various formats (e.g., hydraulic signals, voltage signals, current signals, CAN messages, optical signals, radio signals).

The attachment controller 64 may be in communication with other components on the mower implement 20 and/or windrow sensing attachment 52, such as hydraulic components, electrical components, and operator inputs within an operator station of the tow vehicle or mower implement 20. The attachment controller 64 may be electrically connected to these other components wirelessly or via a wiring harness such that messages, commands, and electrical power may be transmitted between the attachment controller 64 and the other components. Although the attachment controller 64 is referenced in the singular, in alternative embodiments the configuration and functionality described herein can be split across multiple devices using techniques known to a person of ordinary skill in the art.

The attachment controller 64 may be embodied as one or multiple digital computers or host machines each having one or more processors, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and any required input/output (I/O) circuitry, I/O devices, and communication interfaces, as well as signal conditioning and buffer electronics.

The computer-readable memory 98 may include any non-transitory/tangible medium which participates in providing data or computer-readable instructions. The memory 98 may be non-volatile or volatile. Non-volatile media may include, for example, optical or magnetic disks and other persistent memory. Example volatile media may include dynamic random access memory (DRAM), which may constitute a main memory. Other examples of embodiments for the memory 98 include a floppy, flexible disk, or hard disk, magnetic tape or other magnetic medium, a CD-ROM, DVD, and/or any other optical medium, as well as other possible memory devices such as flash memory.

The attachment controller 64 includes the tangible, non-transitory memory 98 on which are recorded computer-executable instructions, including a windrow mapping algorithm 102. The processor 96 of the attachment controller 64 is configured for executing the windrow mapping algorithm 102. The windrow mapping algorithm 102 implements a method of detecting data related to the cross-sectional shape, density, and cop mass of the windrow 22, described in detail below.

The method described herein includes the attachment controller 64 determining an elevation of the arm attachment bar 56, relative to the ground surface 24. The attachment controller 64 may determine the elevation of the arm attachment bar 56 based on the bar position signal from the frame position sensor 62. As described above, with the dimensional characteristics of the mower implement 20 and the windrow sensing attachment 52 known, the attachment controller 64 may calculate a position of the arm attachment bar 56 relative to the ground surface 24, by first determining the position of the arm attachment bar 56 relative to the support structure 26 of the mower implement 20, based on the bar position signal from the frame position sensor 62, and then combining the fixed dimensions of the mower implement 20 relative to the ground with the position of the arm attachment bar 56 relative to the support structure 26, to determine the position of the arm attachment bar 56 relative to the ground surface 24.

The attachment controller 64 may then determine a respective position of each one of the plurality of arms 66 relative to a ground surface 24 from the arm 66 position signal of the arm position sensor 88. As described above, the arm 66 position signal provides data related to the position of each respective arm 66 relative to the arm attachment bar 56. With the position of the arm attachment bar 56 relative to the ground surface 24 determined as described above, the attachment controller 64 may determine the position of each respective arm 66, and particularly the distal contact end 72 of each respective arm 66, relative to the ground surface 24, based on the position of the arm 66 relative to the arm attachment bar 56, and the position of the arm attachment bar 56 relative to the ground surface 24.

In one implementation, the attachment controller 64 may calculate or determine the position of the distal contact end 72 of each respective arm 66 based on the angular orientation of each respective arm 66 relative to the arm attachment bar 56, and a known length of each arm 66. In another implementation, the attachment controller 64 may calculate or determine the position of the distal contact end 72 of each respective arm 66 by analyzing an image to identify a location of a marker 92 on each respective arm 66 relative to the arm attachment bar 56, using the image analysis software 100 as is understood by those skilled in the art. With the position of the marker 92 on each respective arm 66 identified, and knowing the fixed length of each respective arm 66, the attachment controller 64 may determine the location of the distal contact end 72 of each respective arm 66 relative to the arm attachment bar 56. The attachment controller 64 may then combine the location of the distal contact end 72 relative to the arm attachment bar 56 with the position of the arm attachment bar 56 relative to the ground surface 24 to determine the position of the distal contact end 72 of the arms 66 relative to the ground surface 24.

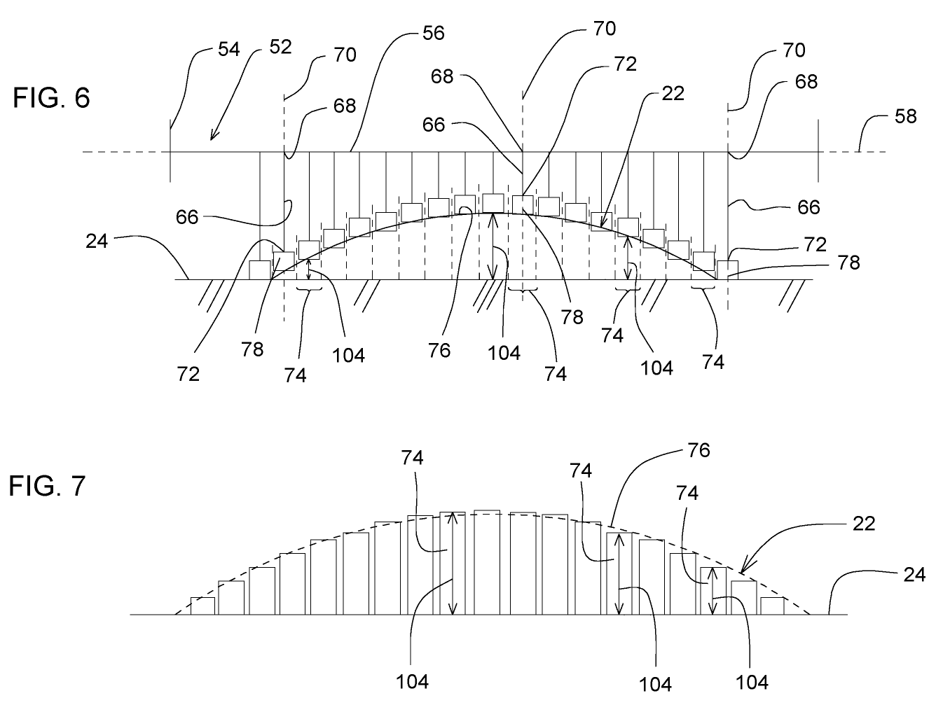

As shown in FIG. 7, the attachment controller 64 may then generate a cross-sectional profile of the windrow 22 (shown in phantom in FIG. 7), extending perpendicular to the direction of travel 34, based on the respective position of each one of the plurality of arms 66 relative to the ground surface 24. As described above, each respective arm 66 is associated with a discrete region 74 of the cross section of the windrow 22. Accordingly, the attachment controller 64 may determine that the location of the distal contact end 72 of each respective arm 66 relative to the ground surface 24 represents the upper surface 76 of the windrow 22 for the respective discrete region 74 associated with that arm 66. The attachment controller 64 may generate the cross-sectional profile based on the location relative to the ground surface 24 of each of the respective arms 66, covering their respective discrete regions 74. The cross -sectional profile may be saved in the memory 98, and/or displayed in a viewer of an associated tow vehicle.

As described above, the attachment controller 64 may estimate a density of the windrow 22 along the cross-sectional profile based the downward force generated at the distal contact end 72 of each one of the plurality of arms 66 acting on the respective discrete region 74 of the windrow 22 to generate a compressive pressure on that discrete region 74 of the windrow 22. The compressive pressure applied to each discrete region 74 may be multiplied by the height 104 of the windrow 22 in that respective discrete region 74 to calculate the density of the windrow 22 in that discrete region 74. In order to do so, the attachment controller 64 may correlate the downward pressure applied onto the upper surface 76 of the windrow 22 and the height 104 of the windrow 22 at that discrete location to a crop density, using a look-up table or other similar process. It should be appreciated that the density may be dependent upon the particular crop type. As such, each particular crop type may include a different look-up table or equation relating the downward pressure onto the windrow 22 and the height 104 of the windrow 22 to a density of the crop material within the windrow 22.

The attachment controller 64 may then estimate a crop mass of the windrow 22 based on the respective density of the respective discrete regions 74 of the windrow 22, and a distance 106 traveled along the windrow 22 in the direction of travel 34. In other words, the attachment controller 64 may continuously calculate and/or determine the density of the windrow 22 in each of the respective discrete regions 74 of the windrow 22 as the windrow sensing attachment 52 is moved longitudinal along the length of the windrow 22. The attachment controller 64 may then integrate the density of the respective discrete regions 74 of the windrow 22 over the distance 106 traveled along the length of the windrow 22 to calculate a cumulative mass and/or volume of the crop material within the windrow 22.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

What is claimed is:

1. A windrow sensing attachment comprising:
a frame assembly configured for attachment to a tow vehicle, and including an arm attachment bar extending along a longitudinal bar axis in a direction transverse to a direction of travel during operation;
a plurality of arms, with each respective one of the plurality of arms having an attachment end pivotably coupled to the arm attachment bar for rotational movement about the longitudinal bar axis, and extending along a longitudinal arm axis substantially parallel to the direction of travel to a distal contact end, wherein the distal contact end is configured to contact and follow a contour of an upper surface of a windrow;
an arm position sensor operable to detect data related to a rotational position of each respective one of the plurality of arms relative to and about the longitudinal bar axis, and generate an arm position signal indicative thereof;
an attachment controller having a processor and a memory having a windrow mapping algorithm stored thereon, wherein the processor is operable to execute the windrow mapping algorithm to:
determine a respective position of each one of the plurality of arms relative to a ground surface from the arm position signal of the arm position sensor; and
generate a cross-sectional profile of the windrow, extending perpendicular to the direction of travel, based on the respective position of each one of the plurality of arms.

2. The windrow sensing attachment set forth in claim 1, wherein the arm position sensor includes a plurality of rotational position sensors, with each respective one of the plurality of arms having a respective one of the plurality of rotational position sensors attached thereto.

3. The windrow sensing attachment set forth in claim 1, wherein the arm position sensor includes a plurality of markers, with each respective one of the plurality of arms having a respective one of the plurality of markers attached thereto.

4. The windrow sensing attachment set forth in claim 3, wherein the arm position sensor includes an image sensor positioned to capture an image of the plurality of markers throughout a range of motion of the plurality of arms.

5. The windrow sensing attachment set forth in claim 4, wherein the processor is operable to execute the windrow mapping algorithm to determine the respective position of each respective arm from the image captured by the image sensor by identifying a location of the marker using an image analysis algorithm.

6. The windrow sensing attachment set forth in claim 1, further comprising a plurality of force generators, with each respective one of the plurality of arms having a respective force generator coupled thereto for generating a downward force at the distal contact end thereof for pressing downward against the windrow with a defined constant force.

7. The windrow sensing attachment set forth in claim 6, wherein each respective one of the plurality of force generators includes a biasing element interconnecting the frame assembly and the respective arm coupled to that respective force generator.

8. The windrow sensing attachment set forth in claim 6, wherein each respective one of the plurality of force generators includes a weight attached to the distal contact end of the respective arm coupled to that respective force generator.

9. The windrow sensing attachment set forth in claim 6, wherein the processor is operable to execute the windrow mapping algorithm to estimate a density of the windrow along the cross-sectional profile based the downward force generated at the distal contact end of each one of the plurality of arms.

10. The windrow sensing attachment set forth in claim 9, wherein the processor is operable to execute the windrow mapping algorithm to estimate a crop mass of the windrow based on the cross-sectional profile of the windrow, the density of the windrow, the cross-sectional profile of the windrow, and a distance traveled along the windrow in the direction of travel.

11. The windrow sensing attachment set forth in claim 1, wherein each respective one of the plurality of arms includes a respective crop contacting element attached to the distal contact end thereof.

12. The windrow sensing attachment set forth in claim 11, wherein each respective crop contacting element includes one of a roller or a skid plate.

13. The windrow sensing attachment set forth in claim 1, further comprising an attachment actuator coupled to the frame assembly and configured for positioning the frame assembly relative to the ground surface.

14. The windrow sensing attachment set forth in claim 13, further comprising a frame position sensor operable to detect data related to the position of the arm attachment bar relative to the ground surface, and generate a bar position signal indicative thereof.

15. The windrow sensing attachment set forth in claim 14, wherein the processor is operable to execute the windrow mapping algorithm to determine an elevation of the arm attachment bar relative to the ground surface from the bar position signal from the frame position sensor.

16. The windrow sensing attachment set forth in claim 1, wherein each respective one of the plurality of arms is independently moveable relative to the others of the plurality of arms.

17. A mower implement comprising:
a support structure;
a crop cutter system coupled to the support structure and configured for cutting standing crop and positioning the cut crop material in a windrow on a ground surface;
a frame assembly attached to the support structure rearward of the crop cutter system relative to a direction of travel during operation, the frame assembly including an arm attachment bar extending along a longitudinal bar axis in a direction transverse to the direction of travel;
a plurality of arms, with each respective one of the plurality of arms having an attachment end pivotably coupled to the arm attachment bar for rotational movement about the longitudinal bar axis, and extending along a longitudinal arm axis substantially parallel to the direction of travel to a distal contact end, wherein the distal contact end is configured to contact and follow an upper surface of a windrow;
an arm position sensor operable to detect data related to a rotational position of each respective one of the plurality of arms relative to and about the longitudinal bar axis, and generate an arm position signal indicative thereof;
a plurality of force generators, with each respective one of the plurality of arms having a respective force generator coupled thereto for generating a downward force at the distal contact end thereof for pressing downward against the windrow with a defined constant force;
an attachment controller having a processor and a memory having a windrow mapping algorithm stored thereon, wherein the processor is operable to execute the windrow mapping algorithm to:
determine a respective position of each one of the plurality of arms relative to a ground surface from the arm position signal of the arm position sensor;
estimate a density of the windrow under the distal contact end of each respective one of the plurality of arms based on the downward force generated at the distal contact end of each one of the plurality of arms;
determine a cross-sectional profile extending perpendicular to the direction of travel of the windrow indicating cross sectional area of the windrow based on the respective position of each one of the plurality of arms; and
estimate a crop mass of the windrow based on the cross-sectional profile of the windrow, the density of the windrow, and a distance traveled along the windrow in the direction of travel.

18. The mower implement set forth in claim 17, further comprising an attachment actuator interconnecting the support structure and the frame assembly and configured for positioning the frame assembly relative to the ground surface.

19. The mower implement set forth in claim 18, further comprising a frame position sensor operable to detect data related to the position of the arm attachment bar relative to the ground surface, and generate a bar position signal indicative thereof.

20. The mower implement set forth in claim 19, wherein the processor is operable to execute the windrow mapping algorithm to determine an elevation of the arm attachment bar relative to the ground surface from the bar position signal from the frame position sensor.
